(19) United States
(12) Patent Application Publication
(10) Pub. No.: US 2024/0321475 A1
(43) Pub. Date: Sep. 26, 2024

(54) CONDUCTIVE FILM, ELECTRODE, AND METHOD FOR PRODUCING CONDUCTIVE FILM

(71) Applicant: Murata Manufacturing Co., Ltd., Nagaokakyo-shi (JP)

(72) Inventors: Kosuke SUGIURA, Nagaokakyo-shi (JP); Takeshi TORITA, Nagaokakyo-shi (JP)

(21) Appl. No.: 18/736,757

(22) Filed: Jun. 7, 2024

Related U.S. Application Data
(63) Continuation of application No. PCT/JP2022/043779, filed on Nov. 28, 2022.

(30) Foreign Application Priority Data
Dec. 8, 2021 (JP) 2021-199517

(51) Int. Cl. H01B 1/08; H01B 5/00

(52) U.S. Cl. CPC H01B 1/08; H01B 5/00

(57) ABSTRACT

A conductive film including: a film including particles of a layered material including one or plural layers; and a titanium oxide. The one or plural layers includes a layer body represented by: MₘXₙ, wherein M is at least one metal of Group 3, 4, 5, 6, or 7, and contains Ti, X is a carbon atom, a nitrogen atom, or a combination thereof, n is 1 to 4, and m is more than n and 5 or less, and a modifier or terminal T existing on a surface of the layer body, wherein T is at least one selected from a hydroxyl group, a fluorine atom, a chlorine atom, an oxygen atom, and a hydrogen atom, and a proportion of tetravalent titanium to divalent, trivalent, and tetravalent titanium in the conductive film, as determined by X-ray photoelectron spectroscopy, is more than 2% by mol and 57% by mol or less.

### CROSS REFERENCE TO RELATED APPLICATIONS

The present application is a continuation of International application No. PCT/JP2022/043779, filed Nov. 28, 2022, which claims priority to Japanese Patent Application No. 2021-199517, filed Dec. 8, 2021, the entire contents of each of which are incorporated herein by reference.

### TECHNICAL FIELD

The present disclosure relates to a conductive film, an electrode, and a method for producing the conductive film.

### BACKGROUND ART

In recent years, MXene has been attracting attention as a new material. MXene is a type of so-called two-dimensional material, and as will be described later, is a layered material in the form of one or plural layers. In general, MXene is in the form of particles (which can include powders, flakes, nanosheets, and the like) of such a layered material.

Currently, various studies are being conducted toward the application of MXene to various fields. For example, application to use such as electrodes in electric devices and electromagnetic shields (EMI shields) in which maintaining of high conductivity is required has been studied. For example, Non-Patent Document 1 discloses that Ti₃C₂MXene, which is a two-dimensional material, is a material clearly different from a carbon-based nanomaterial, and a Ti₃C₂MXene microelectrode is suitable for recording neural signals from a living body, for example, a brain. In addition, Non-Patent Document 2 also discloses that MXene can be effective in many applications ranging from mapping of a wide range of neuromuscular networks of a living body field, for example, human, to cortical microstimulation in a small animal model.

Non Patent Document 1: Driscoll, Nicolette, et al. “Two-dimensional Ti3C2 MXene for high-resolution neural interfaces” ACS nano 12.10 (2018): 10419-10429

Non Patent Document 2: Driscoll, Nicolette, et al. “MXtrodes: MXene-infused bioelectronic interfaces for multiscale electrophysiology and stimulation” bioRxiv (2021)

### SUMMARY OF THE DISCLOSURE

For example, in order to perform high-resolution sensing in the biological field, it is important to reduce the interface impedance as low as possible, but in the electrodes including MXene disclosed in Non-Patent Document 1 and Non-Patent Document 2, it is considered that improvement for the reduction is necessary. The present disclosure has been made in view of the above circumstances, and an object thereof is to provide a conductive film having sufficiently reduced impedance, an electrode including the conductive film, and a method for producing the conductive film.

According to one aspect of the present disclosure, there is provided a conductive film comprising:
a film including particles of a layered material including one or plural layers; and
a titanium oxide,
wherein the one or plural layers includes a layer body represented by:

MₘXₙ
wherein M is at least one metal of Group 3, 4, 5, 6, or 7, and contains Ti, X is a carbon atom, a nitrogen atom, or a combination thereof, n is 1 or more and 4 or less, and m is more than n and 5 or less, and
a modifier or terminal T existing on a surface of the layer body, wherein T is at least one selected from the group consisting of a hydroxyl group, a fluorine atom, a chlorine atom, an oxygen atom, and a hydrogen atom; and
a proportion of tetravalent titanium to divalent, trivalent, and tetravalent titanium in the conductive film, as determined from a spectrum obtained by X-ray photoelectron spectroscopy, is more than 2% by mol and 57% by mol or less.

According to the present disclosure, a conductive film includes a film including particles of a predetermined layered material (also referred to as “MXene” in the present specification) and titanium oxide, and the proportion of tetravalent titanium in divalent, trivalent, and tetravalent titanium, as determined from a spectrum obtained by X-ray photoelectron spectroscopy, is more than 2% by mol and 57% by mol or less, thereby providing a conductive film including MXene and having sufficiently reduced impedance. In addition, an electrode including the conductive film and a producing method capable of easily producing the conductive film are provided.

### BRIEF DESCRIPTION OF THE DRAWINGS

FIGS. 1(a) and 1(b) are a schematic cross-sectional views illustrating MXene constituting a conductive film of the present embodiment.

FIG. 2 is a schematic cross-sectional view for illustrating a conductive film in the related art.

FIG. 3 is a schematic cross-sectional view for illustrating the conductive film of the present embodiment.

FIG. 4 is a scanning electron micrograph of in Examples.

FIG. 5 is a diagram showing a relationship between a proportion of tetravalent titanium and an impedance at 10 Hz of an electrode having a diameter of 10 mm in Examples.

### DETAILED DESCRIPTION

### Embodiment 1: Conductive Film

Hereinafter, a conductive film in one embodiment of the present disclosure will be described in detail, and the present disclosure is not limited to such an embodiment.

According to the present embodiment, there is provided a conductive film comprising a film including particles of a layered material including one or plural layers; and a titanium oxide. The one or plural layers includes a layer body represented by:

MₘXₙ
wherein M is at least one metal of Group 3, 4, 5, 6, or 7, and contains Ti, X is a carbon atom, a nitrogen atom, or a combination thereof, n is 1 or more and 4 or less, and m is more than n and 5 or less, and
a modifier or terminal T existing on a surface of the layer body, wherein T is at least one selected from the group consisting of a hydroxyl group, a fluorine atom, a chlorine atom, an oxygen atom, and a hydrogen atom, and
a proportion of tetravalent titanium in divalent, trivalent, and tetravalent titanium, as determined from a spectrum obtained by X-ray photoelectron spectroscopy, is more than 2% by mol and 57% by mol or less. As a result, a conductive film containing MXene and having sufficiently reduced impedance can be realized.

Hereinafter, a film including particles of layered material including one or plural layers constituting the conductive film of the present embodiment will be described. The layered material can be understood as a layered compound and is also denoted by “MₘXₙTₛ”, in which s is an optional number, and in the related art, x or z may be used instead of s. Typically, n can be 1, 2, 3, or 4, but is not limited thereto.

In the above formula of MXene, M may be only Ti, or may have Ti, and further have at least one selected from the group consisting of Zr, Hf, V, Nb, Ta, Cr, Mo, and Mn. When M contains an element other than Ti, the element other than Ti is more preferably at least one selected from the group consisting of V, Cr, and Mo.

MXenes whose above formula MₘXₙ is expressed as below are known:
Ti₂C, Ti₂N, (Ti, V)₂C, (Ti,Nb)₂C,
Ti₃C₂, Ti₃N₂, Ti₃(CN), (Ti,V)₃C₂, (Ti₂Nb)C₂, (Ti₂Ta)C₂, (Ti₂Mn)C₂, (V₂Ti)C₂, (Cr₂Ti)C₂, (Mo₂Ti)C₂, (W₂Ti)C₂, and
Ti₄N₃, (Ti,Nb)₄C₃, (Ti₂Nb₂)C₃, (Ti₂Ta₂)C₃, (V₂Ti₂)C₃, (Cr₂Ti₂)C₃, (MO₂Ti₂)C₃, (W₂Ti₂)C₃.

Typically in the above formula, M can be titanium or titanium and vanadium and X can be a carbon atom or a nitrogen atom. For example, the MAX phase is Ti₃AlC₂ and MXene is Ti₃C₂Tₛ (in other words, M is Ti, X is C, n is 2, and m is 3).

In the present embodiment, MXene may contain a relatively small amount of remaining A atoms, for example, 10% by mass or less with respect to the original A atoms. The remaining amount of A atoms can be preferably 8% by mass or less, and more preferably 6% by mass or less. However, even if the residual amount of A atoms exceeds 10% by mass, there may be no problem depending on the application and use conditions of the conductive film and the electrode.

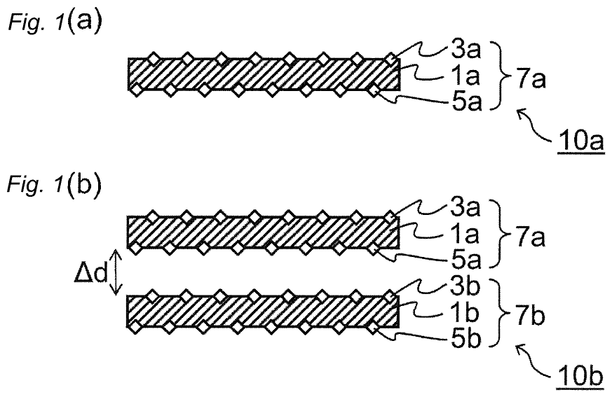

Hereinafter, MXene constituting the MXene particle according to the present embodiment will be described with reference to FIG. 1. The structure corresponding to the skeleton of the MXene particles containing titanium oxide according to the present embodiment is substantially the same as that of the MXene particles constituting the precursor film. In FIG. 1, the structure corresponding to the skeleton of the MXene particles containing titanium oxide is described, and titanium oxide is not shown in FIG. 1.

The MXene particle of the present embodiment is a plurality of aggregates containing one layer of MXene 10a (single-layer MXene) schematically illustrated in FIG. 1(a). More specifically, MXene 10a is an MXene layer 7a having layer body (MₘXₙ layer) 1a represented by MₘXₙ, and modifier or terminals T 3a and 5a existing on the surface (more specifically, at least one of two surfaces of the layer body 1a) of the layer body 1a. Therefore, the MXene layer 7a is also represented as “MₘXₙTₛ”, and s is an optional number.

In the MXene particle according to the present embodiment, MXene may be one layer or a plurality of layers. Examples of the MXene (multilayer MXene) of the plural layers include, but are not limited to, two layers of MXene 10b as schematically illustrated in FIGS. 1(b). 1b, 3b, 5b, and 7b in FIG. 1(b) are the same as la, 3a, 5a, and 7a in FIG. 1(a) described above. Two adjacent MXene layers (for example, 7a and 7b) of the multilayer MXene do not necessarily have to be completely separated from each other, and may be partially in contact with each other. The MXene 10a may be a mixture of the single-layer MXene 10a and the multilayer MXene 10b, in which the multilayer MXene 10b is individually separated and exists as one layer and the unseparated multilayer MXene 10b remains. Even when the multilayer MXene is included, the multilayer MXene is preferably MXene having a small number of layers obtained through the delamination treatment. The term “the number of layers is small” means that, for example, the number of stacked layers of MXene is ten or less. Hereinafter, the “multilayer MXene having a few layers” may be referred to as a “few-layer MXene” in some cases. The thickness, in the stacking direction, of the few-layer MXene is preferably 15 nm or less, and preferably 10 nm or less. In addition, the single-layer MXene and the few-layer MXene may be collectively referred to as “single-layer/few-layer MXene” in some cases.

Many of the MXene may be single-layer/few-layer MXene. Since most of MXene is single-layer/few-layer MXene, the specific surface area of MXene can be made larger than that of multilayer MXene. As a result, for example, when the laminate is used for applications requiring conductivity, deterioration of conductivity over time can be suppressed. For example, the single-layer/few-layer MXene, in which the number of stacked layers of MXene is 10 layers or less and the thickness is 15 nm or less and preferably 10 nm or less, may account for, for example, 80% by volume or more, more preferably 90% by volume or more, and still more preferably 95% by volume or more in the total MXene. In addition, the volume of the single-layer MXene may be larger than the volume of the few-layer MXene. Since the true density of these MXenes does not greatly vary depending on the existence form, it can be said that the mass of the single-layer MXene is larger than the mass of the few-layer MXene. When these relationships are satisfied, the specific surface area of MXene can be increased, and when used for the applications in which conductivity is required, the deterioration of the conductivity over time can be suppressed. For example, the film may be formed of only the single-layer MXene.

Although the present embodiment is not limited, the thickness of each layer of MXene (which corresponds to the MXene layers 7a and 7b) can be, for example, 1 nm or more and 30 μm or less, for example, it may be 1 nm or more and 5 nm or less, and 1 nm or more and 3 nm or less (which may mainly vary depending on the number of M atom layers included in each layer). For the individual laminates of the multilayer MXene that can be included, the interlayer distance (alternatively, a void dimension which is indicated by Δd in FIG. 1(b)) is, for example, 0.8 nm or more and 10 nm or less, particularly 0.8 nm or more and 5 nm or less, and more particularly about 1 nm, and the total number of layers can be 2 or more and 20,000 or less.

The conductive film of the present embodiment contains titanium oxide. In the present embodiment, the proportion of titanium oxide contained in the conductive film is evaluated by the proportion of tetravalent titanium constituting titanium oxide. That is, titanium includes, for example, divalent and trivalent titanium forming the structure of MXene in addition to tetravalent titanium constituting titanium oxide. In the present embodiment, the proportion of tetravalent titanium to divalent, trivalent, and tetravalent titanium, as determined from a spectrum obtained by X-ray photoelectron spectroscopy (XPS), is in the range of more than 2% by mol and 57% by mol or less. Within the above range, it is considered that the titanium oxide can partially change the structure of the MXene film as described below and enhance the conductivity without deteriorating the conductivity inherent in the MXene film.

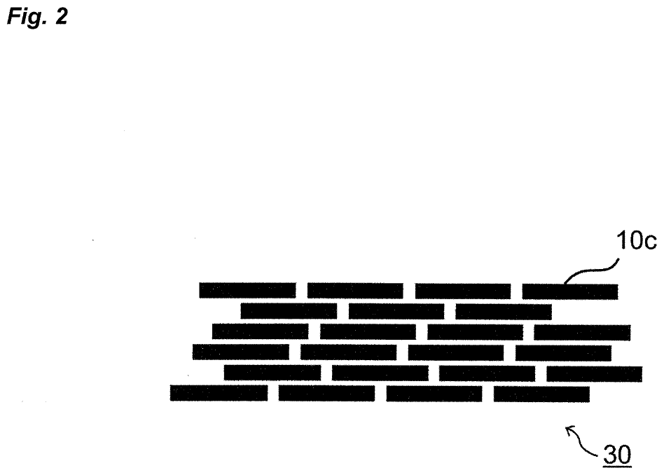

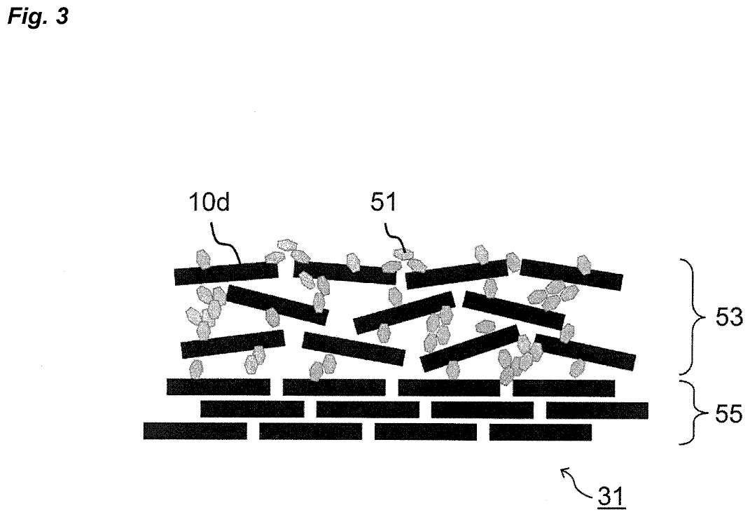

FIG. 2 is a cross-sectional view schematically illustrating the conductive film in the related art. On the other hand, FIG. 3 is a schematic view schematically illustrating a conductive film according to the present embodiment. Note that, FIG. 3 is an image diagram used for convenience of description, and the shape, size, and the like of the crystal of titanium oxide, the arrangement in the MXene film, the arrangement of the MXene particles, and the like are expressed for ease of description, and are not limited to the form illustrated in FIG. 3. Although the present embodiment is not bound by any theory, the reason why the conductive film according to the present embodiment exhibits excellent conductivity is presumed as follows. That is, as illustrated in FIG. 3, it is considered that by realizing a state in which a titanium oxide 51 exists in the vicinity of the surface of a MXene 10d, the titanium oxide 51 enters between the layers of the MXene 10d and spreads the layers. In this state, for example, when applied to an electrode, it is considered that, in the conductive film in the related art in FIG. 2, ions in an electrolytic solution are in contact only with the outermost surface of the conductive film, whereas in the conductive film of FIG. 3, the electrolytic solution enters a surface layer region 53 having a shallow depth in a film thickness direction of the conductive film, and ions in the electrolytic solution are also in contact with the surface of the MXene layer in the inner portion. Accordingly, it is considered that not only the outermost surface of the conductive film but also the layer of MXene in the inner portion acts as an electrode, and the impedance decreases. On the other hand, it is considered that an inner region 55 deeper from the outermost surface of the conductive film is formed by stacking layers of MXene and exhibits an effect as an extraction electrode which MXene originally has. As a result, it is considered that a decrease in impedance due to the above effect is sufficiently exhibited while an increase in impedance due to titanium oxide is suppressed, thereby high conductivity is exhibited.

The titanium oxide is preferably one obtained by oxidizing titanium constituting MXene by aging described later.

### Embodiment 2: Electrode

The electrode according to the present embodiment includes the conductive film. The electrode may be formed of only the conductive film, or may include the conductive film and, for example, a substrate.

The electrode of the present embodiment only needs to include the conductive film, and is not limited to a specific form. Examples of the electrode include an electrode in a solid state and an electrode in a flexible and soft state.

One of the characteristics of the electrode of the present embodiment is impedance. According to the measurement conditions shown in Examples described later, for example, it is preferably 49.0 ohm or less, more preferably 45.0 ohm or less, and still more preferably 30.0 ohm or less at 10 Hz.

In the electrode of the present embodiment, the conductive film may be exposed to the outside air so as to be brought into direct contact with an object to be measured, or as another laminate, a gel capable of permeating ions, a film including a porous membrane, or the like may be formed. The porous membrane may be a membrane having a large number of fine pores and capable of selectively transmitting ions and molecules having a size smaller than a pore diameter. The materials for these other laminates are not particularly limited and may be formed of organic materials, inorganic materials, or mixtures thereof. Polymers such as hydrophilic polymers as the organic materials, and ceramics as the inorganic materials, or a combination thereof can be exemplified. The film thickness of the other laminates may be, for example, 0.1 μm or more and 300 μm or less. The porous membrane may have, for example, an average pore diameter of 1 nm or more and 1 μm or less. The porous membrane may be, for example, an aggregated particulate porous membrane, a network porous membrane, a fibrous porous membrane, a porous membrane having a plurality of isolated and/or communicating pipe holes, a porous membrane having a honeycomb structure, or the like, depending on the pore shape.

When the electrode of the present embodiment includes a substrate, the conductive film and the substrate may be brought into direct contact with each other. The material of the substrate is not particularly limited. The substrate may be formed of a conductive material. Examples of the conductive material include at least one material of metal materials such as gold, silver, copper, platinum, nickel, titanium, tin, iron, zinc, magnesium, aluminum, tungsten, and molybdenum, or a conductive polymer. The substrate may include a conductive film, such as a metal film, different from the conductive film according to the present embodiment on a contact surface with the conductive film according to the present embodiment. Alternatively, the substrate may be formed of an organic material. Examples of the organic material include flexible organic materials, such as a thermoplastic polyurethane elastomer (TPU), a PET film, and a polyimide film.

### Application of Electrode

The electrode of the present embodiment can be used for any appropriate application. Examples thereof include a bioelectrode, an electrode for a battery, a counter electrode or a reference electrode in electrochemical measurement, and an electrode for an electrochemical capacitor. It may be used in applications where maintaining high conductivity (to reduce a decrease in initial conductivity and prevent oxidation) is required, such as electromagnetic shielding (EMI shielding). Details of these applications will be described below.

The electrode is not particularly limited, and may be, for example, a capacitor electrode, a battery electrode, a biosignal sensing electrode, a sensor electrode, an antenna electrode, or the like. By using the conductive film of the present embodiment, it is possible to obtain a large-capacity capacitor and battery, a low-impedance biosignal sensing electrode, and a highly sensitive sensor and antenna, even with a smaller volume (device occupied volume).

The capacitor may be an electrochemical capacitor. The electrochemical capacitor is a capacitor using capacitance developed due to a physicochemical reaction between an electrode (electrode active material) and ions (electrolyte ions) in an electrolytic solution, and can be used as a device (power storage device) that stores electric energy. The battery may be a repeatedly chargeable and dischargeable chemical battery. The battery may be, for example, but not limited to, a lithium ion battery, a magnesium ion battery, a lithium sulfur battery, a sodium ion battery, or the like.

The biosignal sensing electrode is an electrode for acquiring a biological signal. The biosignal sensing electrode may be, for example, but not limited to, an electrode for measuring electroencephalogram (EEG), electrocardiogram (ECG), electromyogram (EMG), electrical impedance tomography (EIT).

The sensor electrode is an electrode for detecting a target substance, state, abnormality, or the like. The sensor may be, for example, but not limited to, a gas sensor, a biosensor (a chemical sensor utilizing a molecular recognition mechanism of biological origin), or the like.

The antenna electrode is an electrode for emitting an electromagnetic wave into a space and/or receiving an electromagnetic wave in the space.

The electrode of the present embodiment is preferably used as a biosignal sensing electrode. As described above, in the conductive film made of MXene moderately containing titanium oxide, the impedance hardly increases due to titanium oxide, and it is considered that the impedance decreases as the distance between the flakes of MXene in the surface layer region increases. As a result, it is considered that the sensitivity is increased when the biosignal sensing electrode is used.

### Embodiment 3: Method for Producing Conductive Film

Hereinafter, a method for producing a conductive film according to the present disclosure will be described in detail, but the present disclosure is not limited to such an embodiment.

According to another aspect of the present embodiment, there is provided a method for producing a conductive film (first producing method), the method comprising:
(a) preparing particles of a layered material including one or plural layers, wherein the one or plural layers includes a layer body represented by:

MₘXₙ
wherein M is at least one metal of Group 3, 4, 5, 6, or 7, and contains Ti, X is a carbon atom, a nitrogen atom, or a combination thereof, n is 1 or more and 4 or less, and m is more than n and 5 or less, and
a modifier or terminal T existing on a surface of the layer body, wherein Tis at least one selected from the group consisting of a hydroxyl group, a fluorine atom, a chlorine atom, an oxygen atom, and a hydrogen atom;
(b) forming a precursor film including the particles of the layered material using the particles of the layered material; and
(c) obtaining a conductive film by performing aging on the precursor film,
wherein a proportion of tetravalent titanium in divalent, trivalent, and tetravalent titanium, as determined from a spectrum obtained by X-ray photoelectron spectroscopy, is more than 2% by mol and 57% by mol or less.

According to still another aspect of the present embodiment, there is provided a method for producing a conductive film (second producing method), the method comprising:
(A) preparing particles of a layered material including one or plural layers, wherein the one or plural layers includes a layer body represented by a formula below:

MₘXₙ
wherein M is at least one metal of Group 3, 4, 5, 6, or 7, and contains Ti, X is a carbon atom, a nitrogen atom, or a combination thereof, n is 1 or more and 4 or less, and m is more than n and 5 or less, and
a modifier or terminal T existing on a surface of the layer body, wherein T is at least one selected from the group consisting of a hydroxyl group, a fluorine atom, a chlorine atom, an oxygen atom, and a hydrogen atom;
(B) performing aging of a dispersion containing the particles of the layered material; and
(C) forming a conductive film containing particles of the layered material subjected to the aging by using the dispersion containing the particles of the layered material subjected to the aging,
wherein a proportion of tetravalent titanium in divalent, trivalent, and tetravalent titanium, as determined from a spectrum obtained by X-ray photoelectron spectroscopy, is more than 2% by mol and 57% by mol or less. Hereinafter, each step of the first producing method and the second producing method will be described in detail. The step (a) and the step (A) common to these two producing methods will be collectively described.

### Step (a) and Step (A)

First, a predetermined precursor is prepared. A predetermined precursor that can be used in the present embodiment is a MAX phase that is a precursor of MXene, and is represented by a formula below:

MₘAXₙ
wherein M is at least one metal of Group 3, 4, 5, 6, or 7, and contains Ti, X is a carbon atom, a nitrogen atom, or a combination thereof, A is at least one element of Group 12, 13, 14, 15, or 16, n is 1 or more and 4 or less, and m is more than n and 5 or less.

The above M, X, n, and m are as described in MXene. A is at least one element of Group 12, 13, 14, 15, or 16, is usually a Group A element, typically Group IIIA and Group IVA, more specifically, may include at least one selected from the group consisting of Al, Ga, In, TI, Si, Ge, Sn, Pb, P, As, S, and Cd, and is preferably Al.

The MAX phase has a crystal structure in which a layer constituted by A atoms is located between two layers represented by MₘXₙ (each X may have a crystal lattice located in an octahedral array of M). When typically m=n+1, but not limited thereto, the MAX phase includes repeating units in which each one layer of X atoms is disposed in between adjacent layers of n+1 layers of M atoms (these are also collectively referred to as an “MₘXₙ layer”), and a layer of A atoms (“A atom layer”) is disposed as a layer next to the (n+1)th layer of M atoms.

The MAX phase can be produced by a known method. For example, a TiC powder, a Ti powder, and an Al powder are mixed in a ball mill, and the obtained mixed powder is calcined under an Ar atmosphere to obtain a calcined body (block-shaped MAX phase). Thereafter, the calcined body obtained is pulverized by an end mill to obtain a powdery MAX phase for the next step.

The A atom layer (and optionally a part of the M atoms) is removed by selectively etching (removing and optionally layer-separating) the A atoms (and optionally a part of the M atoms) from the MAX phase. The surface of the exposed MₘXₙ layer is modified by hydroxyl groups, fluorine atoms, chlorine atoms, oxygen atoms, hydrogen atoms, etc., existing in an etching liquid (usually, an aqueous solution of a fluorine-containing acid is used, but not limited thereto), so that the surface is terminated.

The etching can be carried out using an etching liquid containing F⁻, and a method using, for example, a mixed liquid of lithium fluoride and hydrochloric acid, a method using hydrofluoric acid, or the like may be used. The etching liquid contains a metal compound containing monovalent metal ions, and intercalation treatment of monovalent metal ions may be performed simultaneously with the above etching. Examples of the metal compound containing a monovalent metal ion include those used in the following intercalation treatment. The content of the metal compound containing monovalent metal ions in the etching liquid is preferably 0.001% by mass or more. The content is more preferably 0.01% by mass or more, and still more preferably 0.1% by mass or more. On the other hand, from the viewpoint of dispersibility in a solution, the content of the metal compound containing a monovalent metal ion in the etching liquid is preferably 10% by mass or less, and more preferably 1% by mass or less.

After etching, the layer separation (delamination, separating multilayer MXene into single-layer MXene) of MXene may be promoted by any appropriate post-treatment (for example, ultrasonic treatment, handshaking, automatic shaker, or the like) as appropriate. Since the shear force of an ultrasonic treatment is too large so that the MXene can be destroyed, it is desirable to apply appropriate shear force by handshake, an automatic shaker or the like, when it is desired to obtain a two-dimensional MXene (preferably single-layer MXene) having a larger aspect ratio.

For the layer separation of MXene, the following intercalation treatment and delamination may be performed.

### Intercalation Treatment

For example, the intercalation treatment of monovalent metal ions including a step of mixing the etched product obtained by the etching treatment with a metal compound containing monovalent metal ions may be performed. Examples of the monovalent metal ions constituting the metal compound containing the monovalent metal ions include alkali metal ions such as a lithium ion, a sodium ion, and a potassium ion, a copper ion, a silver ion, and a gold ion. Examples of the metal compound containing a monovalent metal ion include an ionic compound in which the metal ion and a cation are bonded. Examples of the metal ions include an iodide, a phosphate, a sulfide salt including a sulfate, a nitrate, an acetate, and a carboxylate. The monovalent metal ion is preferably a lithium ion, and the metal compound containing a monovalent metal ion is preferably a metal compound containing a lithium ion, more preferably an ionic compound of a lithium ion, and still more preferably one or more of an iodide of a lithium ion, a phosphate of a lithium ion, and a sulfide salt of a lithium ion. When a lithium ion is used as the metal ion, it is considered that water hydrated to the lithium ion has the most negative dielectric constant, and thus it is easy to form a single layer.

The content of the metal compound containing a monovalent metal ion in the formulation for the intercalation treatment of a monovalent metal ion is preferably 0.001% by mass or more. The content is more preferably 0.01% by mass or more, and still more preferably 0.1% by mass or more. On the other hand, from the viewpoint of dispersibility in a solution, the content of the metal compound containing a monovalent metal ion is preferably 10% by mass or less, and more preferably 1% by mass or less.

### Delamination

Delamination may be performed using the intercalated product obtained by intercalation. For example, delamination includes a step of centrifuging the intercalated product and washing the remaining precipitate with water after discarding the supernatant. The conditions for delamination treatment are not particularly limited. A dispersion medium used for delamination is not particularly limited, and examples thereof include performing delamination using one or more of a polar organic dispersion medium and an aqueous dispersion medium. For example, adding and stirring one or more of the polar organic dispersion medium and the aqueous dispersion medium, and centrifuging the mixture to recover the supernatant may be repeated once or more, preferably twice or more and 10 times or less to obtain the supernatant containing the single-layer/few-layer MXene as the delaminated product. Alternatively, the supernatant may be centrifuged, and the supernatant after centrifugation may be discarded to obtain a single-layer/few-layer MXene-containing clay as a delaminated product.

### Step (b)

In the first producing method, the precursor film including the particles of the layered material is formed by using the particles of the layered material. For the formation of the precursor film, a dispersoid of the particles (MXene particles) of the layered material such as MXene slurry obtained by diluting the single-layer/few-layer MXene-containing clay with a medium liquid can be used. The dispersoid may be a suspension. A method for forming the MXene film using the dispersoid of MXene particles is not particularly limited. The dispersoid of the MXene particles may be applied to the substrate as it is or after being appropriately adjusted (for example, dilution with a medium liquid, or addition of a binder). Examples of the coating method include a spray coating method in which spray coating is performed using a nozzle such as a one-fluid nozzle, a two-fluid nozzle, or an air brush (a method using a spray coater), a slit coating using a table coater, a comma coater, or a bar coater, a screen printing method, a metal mask printing method, a spin coating, dip coating, or dropping. Examples of the medium liquid include an aqueous medium liquid and an organic medium liquid. The medium liquid constituting the dispersoid of the MXene particles is typically water, and in some cases, other liquid substances may be contained in a relatively small amount (for example, 30% by mass or less, preferably 20% by mass or less based on the whole mass) in addition to water. Examples of the organic medium liquid include N-methylpyrrolidone, N-methylformamide, N,N-dimethylformamide, ethanol, methanol, dimethylsulfoxide, ethylene glycol, and acetic acid.

When the MXene slurry is formed using a spray coater, for example, the MXene slurry is applied to a substrate such as PET or polyimide at an atomization pressure of 0.1 MPa or more and 0.5 MPa or less, a distance between a nozzle tip and the substrate of 10 cm or more and 25 cm or less, a liquid feeding amount of 0.1 mL/s or more and 10 mL/s or less, a sweep rate of 1 mm/s or more and 30 mm/s or less, and a stage heater of 30° C. or higher and 60° C. or lower one or more times to form a film (electrode) before drying.

In addition to the preparation of the MXene film by the spraying, the MXene film may be prepared by subjecting the slurry or the supernatant containing MXene particles obtained by the delamination to suction filtration. More specifically, as a dispersoid of the MXene particles, for example, a supernatant containing MXene particles is appropriately adjusted (for example, diluted with an aqueous medium liquid), and is subjected to suction filtration through a filter (which may constitute a predetermined member together with the MXene film, or may be finally separated from the MXene film) installed in a nutsche or the like. Thereby, the aqueous medium liquid is at least partially removed, so that a MXene film can be formed on the filter. The filter is not particularly limited, but a membrane filter or the like can be used. By performing the suction filtration, a MXene film can be produced without using the binder or the like. When the MXene particles of the present embodiment are used, a MXene film can be produced without using a binder or the like as described above.

The substrate may or may not be included. When the substrate is included, the material constituting the substrate is not particularly limited, and may be any appropriate material. The substrate may be, for example, a resin film, a metal foil, a printed wiring board, a mounted electronic component, a metal pin, a metal wiring, a metal wire, or the like. For example, a substrate formed of a metal material, a resin, or the like suitable for the biosignal sensing electrode can be appropriately adopted as the substrate. By coating onto any suitable substrate (which may constitute a predetermined member together with the MXene film, or may be finally separated from the MXene film), a MXene film can be formed on the substrate.

Drying may be performed under mild conditions such as natural drying (typically, it is disposed in an air atmosphere at normal temperature and normal pressure) or air drying (blowing air), or may be performed under relatively active conditions such as hot air drying (blowing heated air), heat drying, and/or vacuum drying. In the present embodiment, the “drying” means removing the medium liquid that can exist in the precursor. The drying may be performed, for example, at a temperature of 400° C. or lower using a normal pressure oven or a vacuum oven. Examples thereof include drying at 30° C. or higher and 200° C. or lower for 30 minutes or more and 24 hours or less.

The forming and drying the MXene film may be appropriately repeated until a desired MXene film thickness is obtained. For example, a combination of spraying and drying may be repeated a plurality of times. According to the suction filtration, the MXene film can be formed without containing a binder. The MXene film may or may not substantially contain liquid components derived from the liquid medium of the slurry.

### Step (c)

The precursor film is subjected to aging to obtain a conductive film in which the proportion of tetravalent titanium to divalent, trivalent, and tetravalent titanium, as determined from a spectrum obtained by X-ray photoelectron spectroscopy (XPS), is in the range of more than 2% by mol and 57% by mol or less.

The conditions for the aging are not particularly limited as long as a conductive film in which the proportion of tetravalent titanium in divalent, trivalent, and tetravalent titanium is more than 2% by mol and 57% by mol or less can be obtained by the aging. The precursor film is left to stand for 24 hours or more and 30 days or less under the conditions of a temperature of 30° C. or higher and 200° C. or lower and a humidity of 45 RH % or more and 99 RH % or less, and the condition that the proportion of the tetravalent titanium is in the range of more than 2% by mol and 57% by mol or less may be appropriately set within the conditions. Within the range of the above conditions, when the temperature is low, it takes time for oxidation, and thus the required aging time is long. On the other hand, when the temperature is high, oxidation is promoted, and thus the required aging time is short. For example, when the temperature is 30° C., which is the lower limit value, the aging time is 30 days or less, which is a longer required time. On the other hand, when the temperature is, for example, 80° C. or higher as in Examples described later, the upper limit of the aging time can be 7 days or less. In the present embodiment, it is preferable to hold the film at a relatively low temperature for a long time for the purpose of partially oxidizing only the surface layer region in the film thickness direction. From this viewpoint, the temperature is more preferably 150° C. or lower, and still more preferably 100° C. or lower. The aging time can be, for example, less than 14 days. From the viewpoint of promoting aging, the temperature may be, for example, 40° C. or higher. From the viewpoint of promoting aging, the humidity may be, for example, 50 RH % or more, and further 60 RH % or more. The atmosphere other than the above for aging is not limited, and may be, for example, an oxygen-containing atmosphere such as air.

According to the first producing method, it is possible to simultaneously produce various electrodes by, for example, producing a plurality of conductive films as electrodes and then performing aging on some electrodes (conductive films) depending on the application, and for example, it is possible to reduce the production cost.

### Step (B)

In the second producing method, the dispersion containing the particles of the layered material is subjected to aging. As a condition of the aging, the dispersion containing the particles of the layered material is left to stand at a temperature of 30° C. or higher and 200° C. or lower for 24 hours or more and 1 month or less (for example, 30 days or less). In the present embodiment, it is preferable to hold the film at a relatively low temperature for a long time for the purpose of partially oxidizing. From this viewpoint, the temperature is more preferably 150° C. or lower, still more preferably 100° C. or lower, further still more preferably 80° C. or lower, and particularly preferably 60° C. or lower. The aging time can be, for example, less than 14 days.

### Step (C)

In the second producing method, using a dispersion containing the particles of the layered material subjected to the aging, a conductive film containing the particles of the layered material, in which a the proportion of tetravalent titanium to divalent, trivalent, and tetravalent titanium, as determined from a spectrum obtained by X-ray photoelectron spectroscopy (XPS), is in the range of more than 2% by mol and 57% by mol or less, is formed. The method for forming a film using the dispersion containing the particles of the layered material subjected to the aging may be the same as the step (b) in the first producing method.

According to the second producing method, for example, by performing aging in a slurry state, it is possible to prepare a large amount of electrodes (conductive films) subjected to the aging at a time, leading to a reduction in production cost. The conductive film obtained by the second producing method also shows the same oxidation degree and impedance value as those of the conductive film obtained by the first producing method. From this, it is considered that the conductive film obtained by the second producing method also has a form of titanium oxide similar to that of the conductive film obtained by the first producing method. The present embodiment is not bound by any theory, but is presumed as follows. That is, it is considered that the particles of the layered material in the dispersion liquid are almost uniformly subjected to aging in the step (B), but it is presumed that titanium oxide moves to the outermost surface of the conductive film due to, for example, a shear force when the dispersion containing the particles of the layered material subjected to aging in the step (C) is applied by, for example, spray coating to form the conductive film. It is considered that such presumption similarly occurs in a forming method other than the above spray.

### EXAMPLES

Hereinafter, the present disclosure will be described more specifically with reference to Examples. The present disclosure is not limited by the following examples, and can be implemented with appropriate modifications within the scope that can be consistent with the above-described and later-described gist, and any of them is included in the technical scope of the present disclosure.

### Example 1

### 1. Preparation of Particles of Layered Material

The MXene particles were first obtained by sequentially performing the following steps described in detail below: (1) preparation of the precursor (MAX), (2) etching of the precursor, (3) washing after etching, (4) intercalation of Li, and (5) delamination.

### (1) Preparation of Precursor (MAX)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1350° C. for 2 hours. The calcined body (block-shaped MAX) thus obtained was pulverized with an end mill to a maximum dimension of 40 μm or less. In this way, Ti₃AlC₂ particles were obtained as a precursor (powdery MAX).

### (2) Preparation of Precursor (MAX)

Using the Ti₃AlC₂ particles (powder) prepared by the above method, etching was performed under the following etching conditions to obtain a solid-liquid mixture (slurry) containing a solid component derived from the Ti₃AlC₂ powder.

### Etching Conditions

Precursor: Ti₃AlC₂ (sieving with a mesh size of 45 μm)
Etching liquid composition: 6 mL of 49% HF,
H₂O 18 mL
HCl (12 M) 36 mL
Amount of precursor input: 3.0 g
Etching container: 100 mL Eyeboy
Etching temperature: 35° C.
Etching time: 24 h
Stirrer rotation speed: 400 rpm

### (3) Washing After Etching

The slurry was equally divided into two portions and inserted into two 50 mL centrifuge tubes. Thereafter, the mixture was centrifuged at 3500 G for 5 minutes using a centrifuge, and then the supernatant was discarded. Thereafter, (i) 35 mL of pure water was added to the remaining precipitate in each centrifuge tube, (ii) stirring was performed by handshake, (iii) centrifugation was performed at 3500 G for 5 minutes, and (iv) the supernatant was removed. The steps (i) to (iv) were repeated 10 times. Finally, centrifugation was performed at 3500 G for 5 minutes to obtain a Ti₃C₂Tₛ-moisture medium clay.

### (4) Li Intercalation

The Ti₃C₂Tₛ-moisture medium clay prepared by the above method was stirred at 20° C. or higher and 25° C. or lower for 12 hours using LiCl as a Li-containing compound according to the following conditions of Li intercalation to perform Li intercalation. The detailed conditions of Li intercalation are as follows.

### Conditions of Li Intercalation

Ti₃C₂Tₛ-moisture medium clay (MXene after washing): solid content 0.75 g
LiCl: 0.75 g
Intercalation container: 100 mL Eyeboy
Temperature: 20° C. or higher and 25° C. or lower (room temperature)
Time: 12 h
Stirrer rotation speed: 800 rpm
   (5) Delamination and Washing with Water

The slurry obtained by Li intercalation was charged into a 50 mL centrifuge tube, centrifuged under the condition of 3500 G using a centrifuge, and then the supernatant was discarded. Next, (i) 40 mL of pure water was added to the remaining precipitate, and the mixture was stirred for 15 minutes with a shaker, then (ii) centrifuged at 3500 G, and (iii) the supernatant was recovered as a single-layer/few-layer MXene-containing liquid. The operations (i) to (iii) were repeated 4 times in total to obtain a single-layer/few-layer MXene-containing supernatant. Further, this supernatant was centrifuged under the conditions of 4300 G and 2 hours using a centrifuge, and then the supernatant was discarded to obtain a single-layer/few-layer MXene-containing MXene clay as a remaining precipitate.

### 2. Preparation of MXene Slurry

The MXene clay obtained in the above 1. was placed in a 50 mL centrifuge tube in a predetermined amount, and pure water was added thereto so that the concentration of MXene was 1.5 wt %. Thereafter, the mixture was stirred on a shaker for 15 minutes to obtain a MXene slurry.

3. Aging of MXene slurry (Nos. 2 to 5 in Table 1)

In Nos. 2 to 5 in Table 1, aging was performed in a slurry state. Specifically, the slurry obtained in the above 2. was placed in a resin container, placed in a normal pressure oven, and left to stand at a temperature of 40° C. for 1 day, 2 days, 3 days, or 6 days to perform aging. For Nos. 6 to 8 in Table 1, aging was not performed in the state of slurry.

### 4. Preparation of Electrode Sample

Using the MXene slurries Nos. 6 to 8 in Table 1 obtained in the above 2. or the aged MXene slurries Nos. 2 to 5 in Table 1 obtained in the above 3., electrode samples were prepared in the following order.
(a) The slurry was placed in a 25 ml syringe.
(b) The syringe of the above (a) was set in a spray coater.
(c) A predetermined number of 3 cm square PET substrates were set on a stage with suction of a spray coater.
(d) The atomization pressure was set to 0.5 MPa, the distance between the nozzle tip and the substrate was set to 15 cm, the liquid feeding amount was set to 5 mL/s, the sweep rate was set to 150 mm/s, and the stage heater was set to 45° C.
(e) An electrode was formed by coating the substrate 12 times.
(f) Drying was performed under conditions of 80° C. and 2 hours using a normal pressure oven to obtain an electrode sample. The electrode samples obtained in Nos. 6 to 8 correspond to precursor films.

### 5. Aging of Electrode Sample (Nos. 6 to 8 in Table 1)

In Nos. 6 to 8 in Table 1, the electrode samples corresponding to the precursor films were aged. Specifically, the electrode samples of Nos. 6 to 8 obtained in the above 4. were placed in a normal pressure oven and left to stand at a temperature of 85° C. and a humidity of 85 RH % for 1 day, 7 days, or 14 days to perform aging. As a comparative example, in No. 1 of Table 1, an electrode sample was prepared without performing aging at all.

### 6. Evaluation of Samples

### (1) Measurement of Impedance

Measurement of the impedance was performed as follows.
(a) A beaker cell was assembled using the obtained electrode sample as a working electrode, a platinum electrode or a carbon electrode as a counter electrode, and a silver-silver chloride electrode as a reference electrode.
(b) The working electrode of the above (a) was an electrode in which an opening having a diameter of 10 mm was provided with a Kapton (registered trademark) tape in the obtained electrode sample.
(c) The counter electrode of the above (a) was larger in area than the working electrode.
(d) As measurement conditions, in a frequency range of 0.1 Hz to 106 Hz, a voltage was set to an open circuit voltage or 1 m Vrms to 20 m Vrms with respect to the reference electrode, the number of plots was set to 71 points, and the number of N per plot was set to 1 to 10, and measurement was performed in a potentiostat mode. As an apparatus, a VMP-300 high-performance electrochemical measurement system (16ch advanced model) manufactured by Bio-Logic Science Instruments was used. As a measurement result, the impedance at 10 Hz of the electrode having a diameter of 10 mm is shown in Table 1.

### (2) Measurement of Oxidation Degree by XPS

The oxidation degree was measured by XPS as follows.
(a) The obtained electrode sample was cut into approximately 5 mm square with scissors together with the substrate.
(b) XPS analysis was performed on both a surface and a peeled surface. As a method for exposing the peeled surface, first, the MXene film formed on the film was transferred to a sticky surface of a cellophane tape, a new cellophane tape was attached to the transferred MXene film, and the MXene film and the cellophane tape were peeled off from each other. The inside of the MXene film exposed at that time was defined as a peeled surface.
(c) For both the surface and the peeled surface of the electrode sample, a narrow spectrum of 450 eV or more and 470 eV or less was acquired using a multifunctional scanning X-ray photoelectron spectrometer (XPS) PHI 5000 VersaProbe III manufactured by ULVAC-PHI, Inc. Then, since tetravalent Ti among divalent, trivalent, and tetravalent Ti is a component derived from titanium oxide, the obtained spectrum was separated into divalent and trivalent Ti and tetravalent Ti, the proportion of the spectrum peak of tetravalent Ti when the total area of these spectrum peaks was 100 was calculated as the proportion of tetravalent Ti, and this calculated value was defined as the “oxidation degree”. The detection depth in the thickness direction of the film of XPS is about 5 nm, and information of the outermost surface is detected. In addition, not information on a specific point but information in a range of 1000 μm×200 μm was obtained by scanning an X-ray having a diameter of 100 μm. The measurement results are shown in Table 1.

### (3) SEM Observation

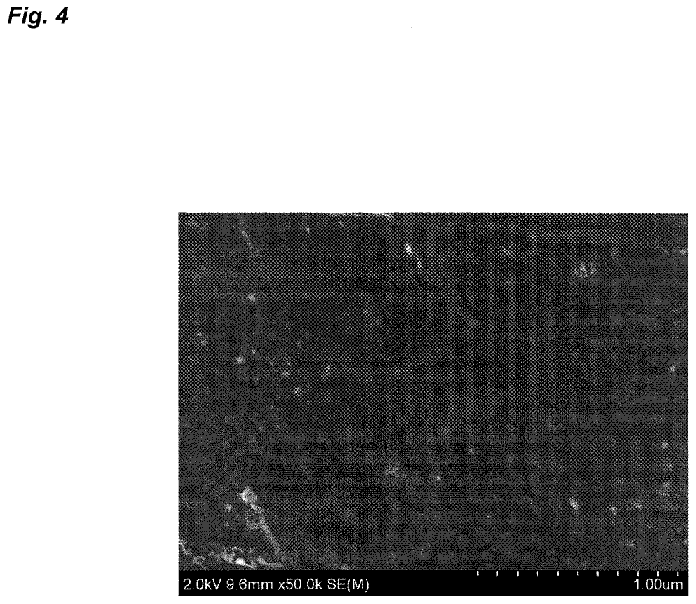

The surface of the electrode sample No. 7 in Table 1 was microscopically observed using a scanning electron microscope (Field emission scanning electron microscope (FE-SEM) S-4800 manufactured by Hitachi High-Technologies Corporation) to obtain a micrograph. The micrograph is shown in FIG. 4. In FIG. 4, it was confirmed that titanium oxide crystals appearing as white particles were precipitated. It is to be noted that the fact that the white granular crystal was titanium oxide was comprehensively determined from three pieces of information: white charge-up, XPS result, and high detection of oxygen in the range observed by EDX.

TABLE 1

| | | | | | Oxidation degree | | |
|---|---|---|---|---|---|---|---|
| | | | | | Proportion | Proportion | |
| | Aging | | | | of Ti (IV) | of Ti (IV) | Impedance |
| | Aging | Thermostat | Leaving | | on surface | on peeled surface | @10 Hz |
| No. | target | condition | time | | [mol %] | [mol %] | [ohm] |
| 1 | No aging | | | | 2 | 2 | 49.1 |
| 2 | Slurry | 40° C. | 1 | day | 8 | 5 | 22.7 |
| 3 | Slurry | 40° C. | 2 | days | 8 | 5 | 25.7 |
| 4 | Slurry | 40° C. | 3 | days | 9 | 4 | 20.1 |
| 5 | Slurry | 40° C. | 6 | days | 10 | 4 | 14.8 |
| 6 | Electrode | 85° C., | 1 | day | 13 | 8 | 28.4 |
| | sample | 85 RH % | | | | | |
| 7 | Electrode | 85° C., | 7 | days | 57 | 13 | 45.4 |
| | sample | 85 RH % | | | | | |
| 8 | Electrode | 85° C., | 14 | days | 72 | 7 | 279.3 |
| | sample | 85 RH % | | | | | |

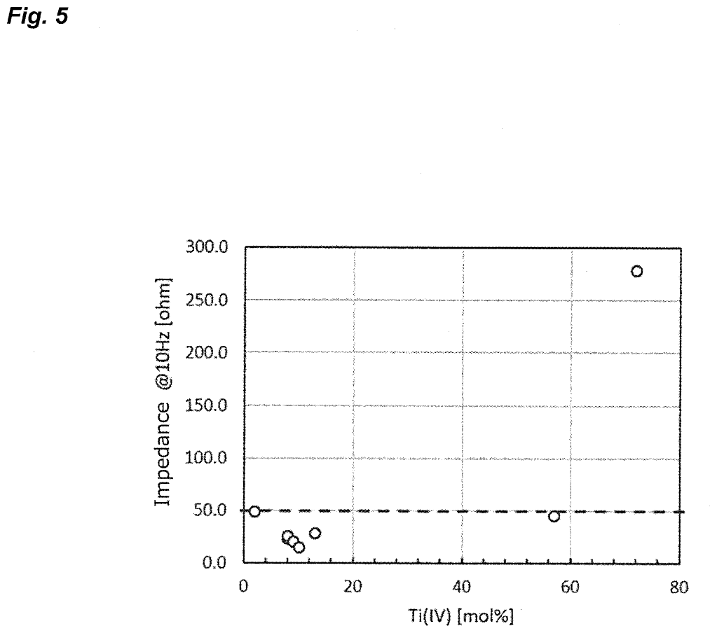

Using the proportion (oxidation degree) of tetravalent Ti on the surface and the value of the impedance of the electrode having a diameter of 10 mm at 10 Hz in Table 1 above, the relationship between them is shown as FIG. 5. From FIG. 5, it was found that the impedance decreased after the proportion of tetravalent titanium exceeded 2% by mol, and the impedance was lower than the initial impedance and high conductivity was exhibited until the proportion reached 57% by mol. That is, it is considered that although oxidation of MXene causes a decrease in conductivity, when the MXene is slightly oxidized within a predetermined range, there is almost no increase in impedance due to titanium oxide, and the presence of titanium oxide increases the distance between the flakes of MXene, so that the effect of decreasing the impedance is increased, and high conductivity is exhibited. On the other hand, when the proportion (oxidation degree) of tetravalent Ti on the surface exceeded 57% by mol and reached 72% by mol, the impedance remarkably increased. Since the aging of the electrode sample in this Example was performed at a high temperature of 85° C., the upper limit of the time required for aging to obtain the MXene film having a proportion of tetravalent titanium of 57% by mol or less was 7 days. In Table 1, the oxidation degree of the peeled surface was lower than the oxidation degree of the surface in all the samples. The proportion of tetravalent titanium on the peeled surface of the film was, for example, 7% by mol in Sample No. 8, and oxidation was suppressed.

The conductive film according to the present embodiment can be used for any appropriate application, but can be preferably used for applications requiring high conductivity, and can be particularly preferably used as, for example, an electrode.

### EXPLANATION OF REFERENCES

1a, 1b Layer body (MₘXₙ layer)
3a, 5a, 3b, 5b Modifier or terminal T
7a, 7b MXene layer
10a, 10b, 10c, 10d MXene (particle)
30 MXene film in the related art
31 MXene film according to the present embodiment
51 Crystal of titanium oxide
53 Surface layer region of MXene film
55 Inner region of MXene film

1. A conductive film comprising:
a film including particles of a layered material including one or plural layers; and
a titanium oxide,
wherein the one or plural layers includes a layer body represented by:
MₘXₙ
wherein M is at least one metal of Group 3, 4, 5, 6, or 7, and contains Ti, X is a carbon atom, a nitrogen atom, or a combination thereof, n is 1 or more and 4 or less, and m is more than n and 5 or less, and
a modifier or terminal T existing on a surface of the layer body, wherein Tis at least one selected from the group consisting of a hydroxyl group, a fluorine atom, a chlorine atom, an oxygen atom, and a hydrogen atom, and
a proportion of tetravalent titanium to divalent, trivalent, and tetravalent titanium in the conductive film, as determined from a spectrum obtained by X-ray photoelectron spectroscopy, is more than 2% by mol and 57% by mol or less.

2. The conductive film according to claim 1, wherein the titanium oxide includes the proportion of tetravalent titanium.

3. The conductive film according to claim 1, wherein the titanium oxide is on the layer body.

4. An electrode comprising:
the conductive film according to claim 1.

5. The electrode according to claim 4, wherein the electrode is a biosignal sensing electrode.

6. A method for producing a conductive film, the method comprising:
(a) preparing particles of a layered material including one or plural layers, wherein the one or plural layers includes a layer body represented by:
MₘXₙ
wherein M is at least one metal of Group 3, 4, 5, 6, or 7, and contains Ti, X is a carbon atom, a nitrogen atom, or a combination thereof, n is 1 or more and 4 or less, and m is more than n and 5 or less, and
a modifier or terminal T existing on a surface of the layer body, wherein T is at least one selected from the group consisting of a hydroxyl group, a fluorine atom, a chlorine atom, an oxygen atom, and a hydrogen atom;
(b) forming a precursor film including the particles of the layered material; and
(c) performing aging on the precursor film to obtain a conductive film having a proportion of tetravalent titanium to divalent, trivalent, and tetravalent titanium, as determined from a spectrum obtained by X-ray photoelectron spectroscopy, of more than 2% by mol and 57% by mol or less.

7. The method for producing a conductive film according to claim 6, wherein in the aging, the precursor film is left to stand for 24 hours or more and 30 days or less at a temperature of 30° C. or higher and 200° C. or lower and a humidity of 45 RH % or more and 99 RH % or less.

8. A method for producing a conductive film, the method comprising:
(A) preparing particles of a layered material including one or plural layers, wherein the one or plural layers includes a layer body represented by:
MₘXₙ
wherein M is at least one metal of Group 3, 4, 5, 6, or 7, and contains Ti, X is a carbon atom, a nitrogen atom, or a combination thereof, n is 1 or more and 4 or less, and m is more than n and 5 or less, and
a modifier or terminal T existing on a surface of the layer body, wherein T is at least one selected from the group consisting of a hydroxyl group, a fluorine atom, a chlorine atom, an oxygen atom, and a hydrogen atom;
(B) aging a dispersion containing the particles of the layered material; and
(C) forming a conductive film containing aged particles of the layered material by using the aged dispersion containing the particles of the layered material such that a proportion of tetravalent titanium to divalent, trivalent, and tetravalent titanium, as determined from a spectrum obtained by X-ray photoelectron spectroscopy, is more than 2% by mol and 57% by mol or less.

9. The method for producing a conductive film according to claim 8, wherein in the aging, the dispersion containing the particles of the layered material is left to stand at a temperature of 30° C. or higher and 200°° C. or lower for 24 hours or more and 30 days or less.
